(19) United States
(12) Patent Application Publication
(10) Pub. No.: US 2006/0064337 A1
(43) Pub. Date: Mar. 23, 2006

(54) Calendaring and messaging device

(76) Inventors: Steven L. Naberhuis, Fremont, CA (US); Huei-Pei Kuo, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/946,735

(22) Filed: Sep. 21, 2004

(51) Int. Cl. G05B 19/418

(52) U.S. Cl. 705/8

(57) ABSTRACT

A limited functionality display device is disclosed. The display device comprises a display arrangement comprising one or more screens that display data, such as schedule related data or calendar data, as well as graphics. The display device has a user interface, such as a series of buttons or scrollbars, that enable user selection of modality and possibly data entry. Memory, processing, and other input modalities may be provided in the device or via a network or other connection.

### BACKGROUND OF THE INVENTION

1. Field of the Invention

The present invention relates generally to the field of electronic display devices, and more particularly to devices useful in storing and displaying common information, such as schedules and messages.

2. Description of the Related Art

Currently available electronic devices used for displaying calendars and date information include personal computers and PDAs (personal digital assistants). Such devices enable a user to maintain and display data relevant to the user's personal schedule or messages and notes of importance to the user. These devices offer access to information and the ability for the user to alter the information as required, such as adding an event to the calendar.

The devices used to operate the aforementioned calendaring and messaging functions, namely personal computers and PDAs, suffer from certain logistical drawbacks. A personal computer typically includes functionality far beyond the calendaring and messaging feature, and can include storage and processing capacities far beyond the level needed for the calendaring and messaging functions. Simply put, a person who only wishes to have calendar and messaging functionality would not require nor have the need for a personal computing device, and such a device to simply keep a calendar of dates, events, and messages would be relatively expensive. PDAs, while portable and dockable, have limited screen size and functionality, and further may have limited graphical capabilities. Many of the PDAs available today have displays smaller than twenty square inches. Thus, use of these devices requires the user to be a relatively short distance, such as within five feet, of the PDA display.

Persons having limited computational needs and a desire for a full calendaring and messaging functionality have few feasible options. One such option is a paper calendar, typically a folding set of pages stapled at the midline thereof with dates listed below the staple when normally displayed and different images or graphics displayed above the staple under typical viewing conditions. Limitations of the paper calendar are the inability to readily change dates or to provide date specific or message specific indications, and a relatively fixed set of images or graphics available for display. Further, the user needs to replace the paper calendar every year, and the lack of a perpetual solution can be a drawback particularly in that anniversaries, birthdays and like yearly occurrences must be entered on the replacement paper calendar.

It would be advantageous to offer a calendaring and messaging device that provides enhanced functionality over paper calendars, is less expensive than personal computing devices, and provides enhanced visual qualities over PDAs.

### SUMMARY OF THE INVENTION

According to a first aspect of the present design, there is provided a display device, the display device comprising at least one screen configured to display calendar related information together with graphics, and a user interface for entering calendar information displayable within the calendar related information on the at least one screen.

According to a second aspect of the present design, there is provided a calendaring display device, comprising at least one display screen configured to display calendar information, a memory capable of maintaining calendar related information, a processor capable of processing calendar related information for display using the at least one display screen, wherein at least a portion of the calendar related information is maintainable within the memory, and a user interface capable of interfacing with said processor to provide calendar related information desired by a user for processing and display on the at least one display screen.

According to a third aspect of the present design, there is provided a limited functionality display device, comprising at least one screen capable of solely displaying graphics and schedule related data, and a user interface connectable to said at least one screen enabling a user to enter schedule related data for processing and display on said at least one screen as part of the schedule data.

These and other objects and advantages of all aspects of the present invention will become apparent to those skilled in the art after having read the following detailed disclosure of the preferred embodiments illustrated in the following drawings.

### DESCRIPTION OF THE DRAWINGS

The present invention is illustrated by way of example, and not by way of limitation, in the figures of the accompanying drawings in which:

FIG. 1 illustrates a first embodiment of the current design;

FIG. 2 shows a general conceptual illustration of the current design;

FIG. 3 is a detailed illustration of a calendar display in accordance with specific aspects of the present design; and

FIG. 4 illustrates one alternative embodiment of the current design using three display areas.

### DETAILED DESCRIPTION OF THE INVENTION

The present invention is a device having calendaring and messaging functionality with visually pleasant qualities, including the ability to display different graphics and graphical information. Information may be edited on the device, and the device may be used in either a home or business environment. The device includes a flat display having a processor and storage associated therewith, and may be split in half to appear as a typical paper calendar with the ability to change graphics based on user preference.

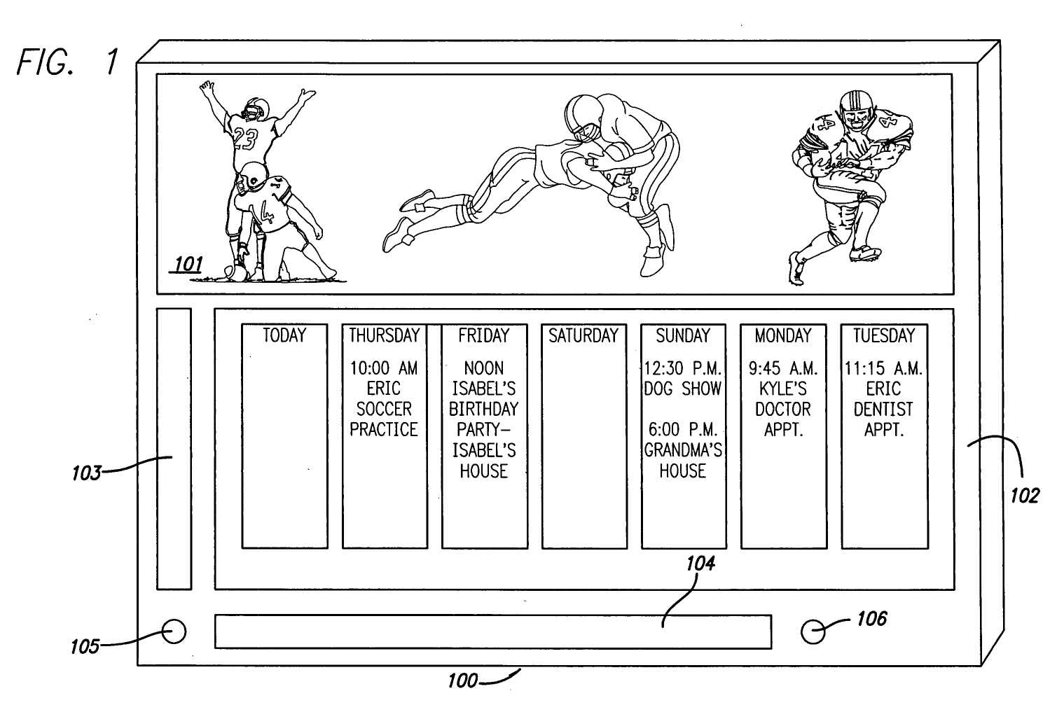

FIG. 1 illustrates one embodiment of a device according to the present design. The device 100 in the illustrated embodiment comprises two displays, upper display 101 and lower display 102, fashioned from, for example, a full color liquid crystal display of laptop size. Such screens are readily available from laptop screen manufacturers and are available in different sizes, including 11 to 15 inch diagonal screen sizes. Such an embodiment may provide the ability to display graphical images such as photographs, artistic work, and the like and/or full motion video. An alternative embodiment of the present design may be a monochrome display capable of high resolution display, such as on the order of at least 100 dots per inch. The monochrome display may include the potential for area color. In one embodiment, upper display 101 may comprise a 15 inch liquid crystal display while lower display 102 may comprise a monochrome display. Calendar dates may be displayed using a monochrome display, while graphics may be displayed using an LCD or other applicable color display technology. Other implementations are possible. A single display screen or more than two screens may be used. Screens having different dimensions may be employed in the current design. Screens readily viewable from a distance of greater than arm's length, and in many cases across a room, may be employed. In normal everyday use, such a device as shown by device 100 may be employed in a home, at a business, or on any type of wall or space where a calendar and messaging device may be useful. For example, the present device may be installed on a kitchen wall or a highly trafficked area of a single family residence or apartment. This functionality dictates that such a device is preferred to be relatively thin; thus, rear projection or other relatively thick devices are not necessarily applicable. Such devices may be used in certain circumstances where thickness is not an issue, for example where the device may be inserted into a space within a wall. While the actual dimensions of the device may vary, one implementation of the device 100 may be on the order of 0.5 to 1.5 inches thick. Other dimensions may be employed successfully.

The device as shown may include controls, such as a vertical scroll bar 103 for scrolling in the vertical or y direction, a horizontal scroll bar 104 for scrolling in the horizontal direction, and certain buttons providing for, for example, power at power button 105 and selection modality button 106. Other inputs may be made available, including additional or different buttons, switches, slide, touch pad, pen, mouse type inputs, microphone, or touch screen technology. Wired or wireless keyboards could also be employed for inputs. Indeed, the input devices may differ from those shown in FIG. 1. For example, a video camera and microphone could be incorporated for messaging. The illustrations of FIG. 1 are intended to be options representative and not limiting as to the form of control or controls available for providing information to the device.

From the illustration of FIG. 1, single direction touch pads may be provided as vertical scroll bar 103 and/or horizontal scroll bar 104. Alternative technology may be employed, such as a single x-y or bidirectional touch pad. The device 100 enables scrolling from week to week on the calendar, or month to month. Selection modality button 106 can be used to select among functions, including in coordination with a series of menus (not shown) for additional functionality.

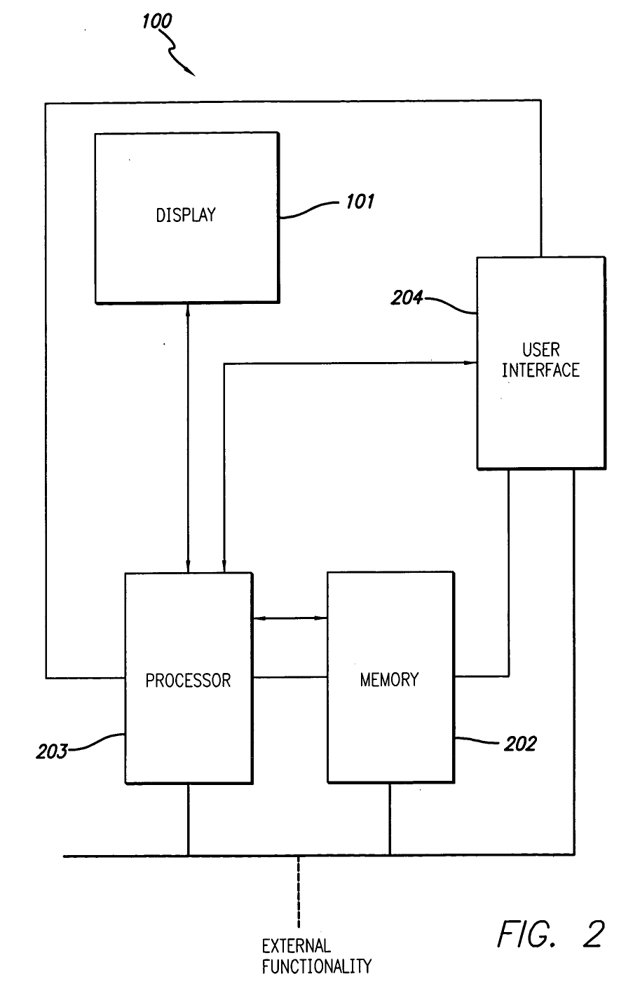

FIG. 2 is a functional depiction of the elements of the present device. Display 201 may comprise any number of display elements, such as the two displays 101 and 102 illustrated in FIG. 1, or a single such display. The device 100 either has affixed within or to it a memory 202 and a processor 203, or such elements may be remotely located and accessible by means known to those skilled in the art, including but not limited to wired and/or wireless connectivity, such as currently available Wi-Fi (802.11a,b,g) and/or Bluetooth communication links. In other words, the processor and storage may be located in a separate hardware component, accessible to the user to change functionality of the device 100, where any changes initiated by the user or dictated by the processor 203 or memory 202 are provided via wire or wirelessly to the display 201.

The memory 202 may comprise a disk drive, FLASH memory, and/or other non-volatile memory storage means, including but not limited to MRAM, FeRAM, PCRAM and the like.

The device 100 may further include a user interface 204, which may comprise a touchpad, pen input device, a series of buttons such as is shown in FIG. 1, a keyboard, a touchscreen, or other device where the user can enter information or data. Further, the user interface 204 may span more than simply the device. For example, a series of buttons may be provided on the device 100 adjacent to any screen or screens, with a keypad or keyboard located at a position physically separate from the device 100 and associated screen or screens. In such a button—keyboard arrangement, the user may be able to toggle through certain functionality using the on-device buttons, switches, scroll bars, and so forth, while further having the ability to type data in at the keyboard and have data transmitted to the device 100 either by wire or wirelessly. In this manner, the user interface 204 may be used to receive calendar data that is then displayable on a calendar displayed on the screen or screens. Alternatively a computer, PDA or other such device may be employed to send data through an appropriate interconnection modality, such as wireless. With voice recognition capabilities, a user may enter information verbally via an embedded microphone or attached or embedded telephone, for example. Additionally an embedded video camera could be employed.

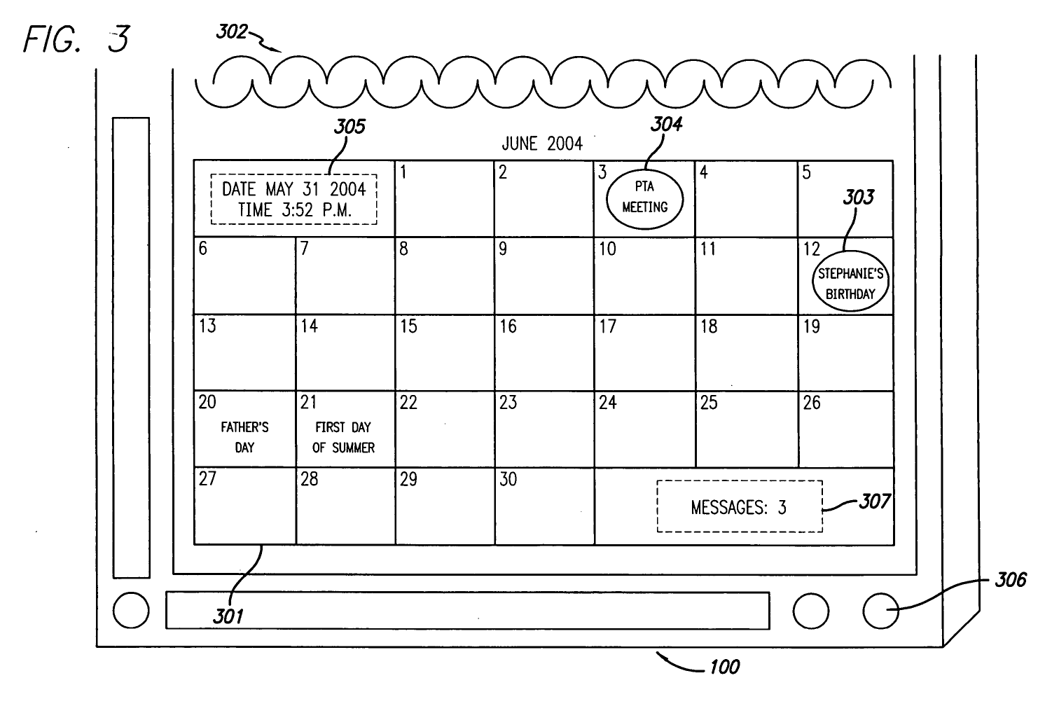

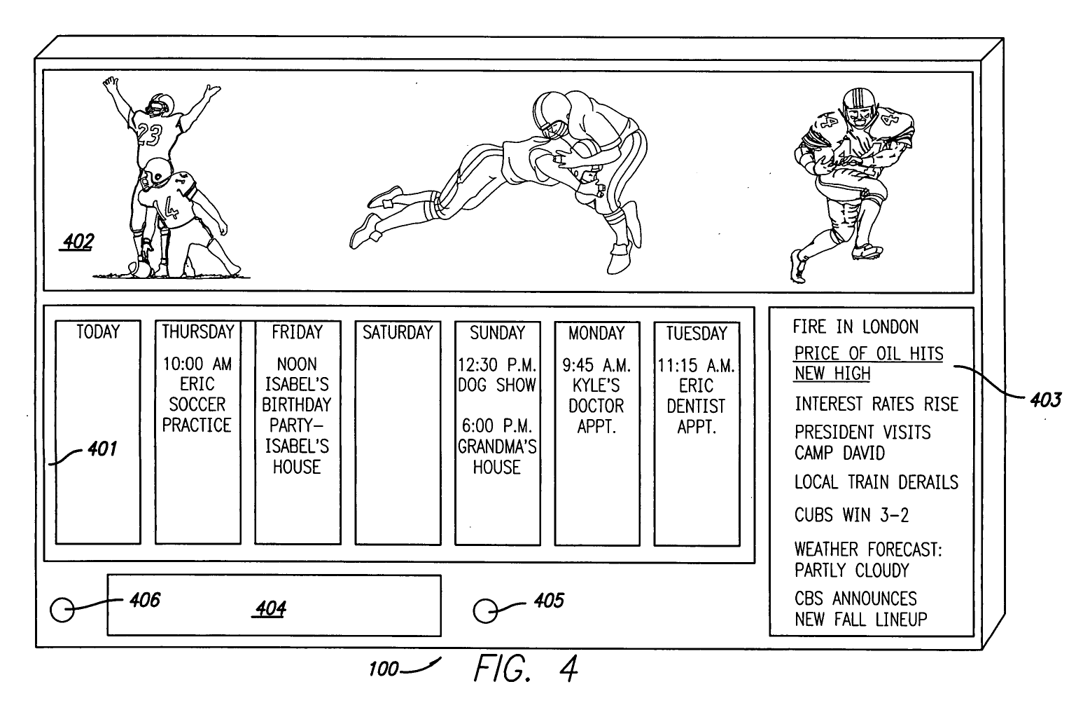

The display of the device 100 may appear similar to a typical printed wall calendar, where the bottom half may represent a calendar and the top half may include graphical information. Such a construction is illustrated in FIG. 3, here using a single display. From FIG. 3, calendar portion 301 is a typical monthly calendar broken down by week, where top half in the embodiment shown includes a graphic 302, with the bottom part of the graphic 302 illustrated in FIG. 3. The graphic 302 may be virtually any graphical representation, including but not limited to family photos, business graphics, animated or dynamic images such as avi or mpeg files, artistic renderings, comics or cartoons, or other selected graphical information or files. The calendar portion 301 may be displayed in other formats, such as monthly or daily or in some other appropriate format. The orientation of graphics with respect to other elements displayed and the orientation of the screen or screens may vary, such as the calendar portion 301 displayed on top of the graphic, or the display may occur in some other reasonable orientation, such as side by side, as shown in FIG. 4, or even distributed on top of or together with the calendar, either as a type of background or as an interlaced or overlaid graphic.

The device 100 may include the ability to receive and display relevant notes or information. For example, point 303 indicates a birthday for Stephanie, while point 304 indicates a PTA meeting. This information may be provided in various ways, including through user input via user interface 204, such as typing into a keypad, or from a remote personal computer, telephone keypad, or PDA, or from a remote location, such as from a network. Thus the user interface 204 may comprise virtually any functional device capable of providing information to the device 100, including but not limited to a pushbutton, a scrollable element, a keyboard, a digital pen, a touch screen, a telephone, a PDA (Personal Digital Assistant), a computer, a microphone, a video camera, an x-y touch pad, and/or a mouse. Another method for providing information is to use a portable storage device such as a USB connected FLASH memory, or other formats including but not limited to compact FLASH, secure digital, or memory stick. Any type of mechanism that can provide calendarable information may be employed to provide these relevant notes and/or information, and these notes and/or information may be editable, removable, or may include reference dates, such as a reminder that a date is coming due within one week or other appropriate timeframe.

The embodiment shown in FIG. 3 further includes display of a clock at point 305, and message functionality, including message button 306 and the number of messages displayed at point 307. The display may have, for example, 1024×768 color resolution in one embodiment, and the overall device may have dimensions of approximately 11 to 12 inches wide by 22 to 24 inches high, but other dimensions may be employed as appropriate.

The alternative embodiment of FIG. 4 includes three screens 401, 402, and 403 in addition to an x-y scrollpad 404, selection element or button 405, and power button 406. Again, these are examples of potential user interfaces and screen configurations; others may be employed while still within the scope of the current design. From FIG. 4, screen 401 displays calendar-related information, screen 402 displays graphical information or graphics, while screen 403 displays alternative information, such as news headlines or other information. Functionality of the user interface or buttons for a design such as is shown in FIG. 4 may include selection from menus of the information to be displayed on the third screen, with selection of particular headlines or other information selectable from submenus navigable using the x-y touch pad 404 in combination with the selection element or button 405. Other data and functionality may be provided displayed in addition to the display of calendar related information, such as to-do list items, electronic mail, a contact list, telephony, telephone messaging, audio messaging, video messaging, news, financial information, networking, a clock, or other pertinent functionality.

The memory 202 used in or with the device 100 may be any type of storage or memory reasonably necessary to hold the information employed by the device 100. When used as a calendar device only, the present device 100 includes sufficient memory to store graphic images and other relevant information, such as calendar information and short video clips, if desired. Such a memory 202 may comprise FLASH memory and/or relatively small sized hard disk drives, such as currently available 2.5, 1.8, 1, and 0.8 inch hard disk drives. Other reasonably available memories may be employed subject to capacities available, cost, and the desired location and dimensionality of the device 100.

Processor 203 may be any reasonable available and compliant processing device, including but not limited to ASICS, low end microprocessors, or even higher end, Intel Pentium class processors if desired. Processing capacity includes the ability to receive the desired information and convert the desired information into the necessary displayable data in appropriate format. The device 100 may receive data via user input 204 or via a network or other external connection, whereby the data is processed and displayed in an appropriate manner. Advanced processing may be required if additional functionality is provided, such as the clock, telephony and/or data retrieval functionality described below. Further, the processor 203 must interact with memory 202 to retrieve relevant information and process the relevant information for display on the screen or screens provided. If full motion video is made available, processing capacity supporting such a data display is provided. Thus the processor 203 must have sufficient capacity to receive the data in the manner provided either by the user or via interface with other devices and interact with the memory 202 and the user interface 204 to provide information to any screen or screens of the device 100.

Further functionality may be provided beyond simple calendaring. Additional functionality may include, for example, telephony, such as a POTS telephone connection to enable communication, phone answering, voice mail, messaging, picture phone functionality, and so forth. Such a telephone connection may be provided on the device 100, and the functionality may require additional hardware, firmware, and software to perform the desired tasks. For example, use as a telephone for communication may require a receiver and transmitter and telephone keypad functionality or hardware. Voice and/or video messaging may require additional devices, such as increased storage, possibly in addition to the telephone components. One alternative to the calendar display arrangement described above is a telephone book display, such as a listing of pertinent information relating to individuals, such as home, business, and mobile telephone numbers, fax numbers, home and business addresses, and so forth, as well as a picture of the individual may be displayed on the device using the screen or screens provided. Dialing capability may be provided from the entry for a particular individual.

The device 100 may also include networking functionality, to enable data transfer between the device 100 and other computing type devices such as personal computers or PDAs. Network connectivity may conform to various standards, but enables uploading or downloading of information as desired and may again be provided with or remote from the device 100. Further functionality may include electronic mail, such as the ability to receive and transmit electronic mail, which can employ keypad input, touch screen input, pen input, or selection input, such as selecting letters by progressing through the alphabet. Using electronic mail functionality, an individual may have the ability to receive electronic mail or electronic messages, either via network connectivity or the telephony connection, as well as respond to those messages or generate new electronic mail messages. Such a system may require electronic mail software and connection to external devices, such as via a network or other common electronic connection, for example a USB, wireless, Ethernet, or IEEE-1394 connection. Wireless connectivity may be built into the device. Further functionality could be the ability to receive and parse data, such as an investment summary, a list of news headlines and associated stories, weather, sports, or traffic information, and so forth. Such functionality may be exhibited using scroll and select user inputs, such as a scrolling bar and a modality selection button. Data may be displayed in lines and a user may scroll through the lines and select desired information to receive further details of, for example, a current news story. Alternatively, financial information may be provided in spreadsheet or other appropriate form, and the user may select the desired information in the appropriate cell or area. Further functionality may include a to-do list, namely a tool to coordinate calendared events with the current day and to add items to a list of tasks to be performed by the user. Such functionality typically dictates the ability to input typed information, which may again be done using a keypad, selecting letters from a list of letters, enabling pen input and character recognition, and so forth. Voice recognition may also be employed. The device 100 may also include a clock that can be periodically synchronized to a time standard, such as through a network connection to the internet. The clock, such as the one shown in FIG. 3, may be displayed on any one of the available displays in the device.

The present design is therefore a perpetual calendaring device having specific functionality facilitating a pleasant display of information. Power may be provided to the device via AC or DC current, such as via a 110 V wall socket, or may alternatively be provided using batteries. Battery backup may be provided in case of power failure to maintain critical information. Backup or synchronizing capability to a personal computer and/or PDA or other computing device may also be provided. With battery operation, the device can be made portable to facilitate the entering of information. One embodiment may have batteries included for limited portability and backup. For normal use, such a device would be powered via AC or DC power from the place in which the device would be regularly employed.

It will be appreciated to those of skill in the art that the present design may be applied to other systems that display information in a pleasant configuration. In particular, it will be appreciated that various display designs may be addressed by the functionality and associated aspects described herein. It is to be specifically understood that the current design is not limited to the exemplary embodiments presented herein, but rather is broader and encompasses designs providing advanced display functionality in accordance with the teachings discussed herein.

Thus, although there has been hereinabove described an apparatus for displaying images in a specific manner, such as a calendar in association with a graphic image, for the purpose of illustrating the manner in which the invention may be used to advantage, it should be appreciated that the invention is not limited thereto. Accordingly, any and all modifications, variations, or equivalent arrangements which may occur to those skilled in the art, should be considered to be within the scope of the present invention as defined in the appended claims.

What is claimed is:

1. A display device, comprising:
at least one screen configured to display calendar related information together with graphics; and
a user interface for entering calendar information displayable within the calendar related information on the at least one screen.

2. The display device of claim 1, further comprising a memory capable of storing calendar related information.

3. The display device of claim 1, wherein a first screen primarily displays calendar information and a second screen primarily displays graphical information.

4. The display device of claim 1, wherein the user interface comprises a series of input elements comprising at least one from a group comprising a pushbutton, a scrollable element, a keyboard, a digital pen, a touch screen, a telephone, a PDA (Personal Digital Assistant), a computer, a microphone, a video camera, an x-y touch pad, and a mouse.

5. The display device of claim 1, wherein said display device has a thickness of less than approximately 1.5 inches.

6. The display device of claim 1, wherein said display device exhibits additional functionality selected from at least one from a group comprising electronic mail, a to-do list, a contact list, telephony, telephone messaging, audio messaging, video messaging, news, financial information, networking, and a clock.

7. The device of claim 1, wherein the at least one screen is wirelessly connected to the user interface.

8. The device of claim 2, wherein the memory includes at least one from a group comprising:
FLASH memory;
a disk drive; and
other non-volatile memory storage means.

9. The device of claim 1, wherein the at least one screen is connected to the wireless interface and information passing therebetween is digitally secured.

10. The device of claim 1, wherein the user interface comprises voice recognition capabilities.

11. The device of claim 1, wherein the at least one screen may display information in a newspaper-like manner.

12. The device of claim 1, wherein the device may be secured to a location and offer limited portability.

13. A calendaring display device, comprising:
at least one display screen configured to display calendar information;
a memory capable of maintaining calendar related information;
a processor capable of processing calendar related information for display using the at least one display screen, wherein at least a portion of the calendar related information is maintainable within the memory; and
a user interface capable of interfacing with said processor to provide calendar related information desired by a user for processing and display on the at least one display screen.

14. The calendaring display device of claim 13, wherein said at least one display screen is further configured to display graphics.

15. The calendaring display device of claim 13, wherein a first screen primarily displays calendar related information and a second screen primarily displays graphical information.

16. The calendaring display device of claim 13, wherein the user interface comprises a series of input elements comprising at least one from a group comprising a pushbutton, a scrollable element, a keyboard, a digital pen, a touch screen, a telephone, a PDA (Personal Digital Assistant), a computer, a microphone, a video camera, an x-y touch pad, and a mouse.

17. The calendaring display device of claim 13, wherein said display device has a thickness of less than approximately 1.5 inches.

18. The calendaring display device of claim 13, wherein said display device exhibits additional functionality beyond calendaring, said additional functionality selected from at least one from a group comprising electronic mail, a to-do list, a contact list, telephony, telephone messaging, audio messaging, video messaging, news, financial information, networking; and a clock.

19. The calendaring display device of claim 13, wherein a connection between the user interface and the processor comprises a wireless connection.

20. The calendaring display device of claim 13, wherein the memory includes at least one from a group comprising:
FLASH memory;
a disk drive; and
other non-volatile memory means.

21. The calendaring display device of claim 13, wherein information passing between the user interface and the processor is digitally secured.

22. The calendaring display device of claim 13, wherein the user interface comprises voice recognition capabilities.

23. The calendaring display device of claim 13, wherein the at least one display screen may display information in a newspaper-like manner.

24. The calendaring display device of claim 13, wherein the device may be secured to a location and offer limited portability.

25. A limited functionality display device, comprising:
a screen arrangement comprising at least one screen, said screen arrangement capable of solely displaying graphics and schedule related data; and
a user interface connectable to said at least one screen enabling a user to enter schedule related data for processing and display on said at least one screen as part of the schedule related data.

26. The limited functionality display device of claim 25, further comprising a memory capable of storing schedule related data.

27. The limited functionality display device of claim 25, wherein said schedule related data comprises calendar related information.

28. The limited functionality display device of claim 25, wherein a first screen primarily displays schedule related data and a second screen primarily displays graphics.

29. The limited functionality display device of claim 25, wherein the user interface comprises a series of input elements comprising at least one from a group comprising a pushbutton, a scrollable element, a keyboard, a digital pen, a touch screen, a telephone, a PDA (Personal Digital Assistant), a computer, a microphone, a video camera, an x-y touch pad, and, a mouse.

30. The limited functionality display device of claim 25, wherein said limited functionality display device has a thickness of less than approximately 1.5 inches.

31. The limited functionality display device of claim 25, wherein said limited functionality display device exhibits limited operational capabilities beyond solely displaying graphics and schedule related data, said capabilities comprising at least one from a group comprising electronic mail, a to-do list, a contact list, telephony, telephone messaging, audio messaging, video messaging, news, financial information, networking, and a clock.

32. The limited functionality display device of claim 25, wherein the screen arrangement is wirelessly connected to the user interface.

33. The limited functionality display device of claim 26, wherein the memory includes at least one from a group comprising:
FLASH memory;
a disk drive; and
other non-volatile memory means.

34. The limited functionality display device of claim 25, wherein the screen arrangement is connected to the wireless interface and information passing therebetween is digitally secured.

35. The limited functionality display device of claim 25, wherein the user interface comprises voice recognition capabilities.

36. The limited functionality display device of claim 25, wherein the at least one screen may display information in a newspaper-like manner.

37. The limited functionality display device of claim 25, wherein the device may be secured to a location and offer limited portability.
